(19) United States
(12) Patent Application Publication
(10) Pub. No.: US 2024/0073884 A1
(43) Pub. Date: Feb. 29, 2024

(54) SYSTEMS AND METHODS FOR SIMULTANEOUS UPLINK TRANSMISSIONS BASED ON MULTI-TRP OPERATION

(71) Applicant: ZTE CORPORATION, Shenzhen (CN)

(72) Inventors: Yang ZHANG, Shenzhen (CN); Bo GAO, Shenzhen (CN); Ke YAO, Shenzhen (CN); Zhaohua LU, Shenzhen (CN); Shijia SHAO, Shenzhen (CN); Wenjun YAN, Shenzhen (CN)

(73) Assignee: ZTE CORPORATION, Shenzhen (CN)

(21) Appl. No.: 18/489,564

(22) Filed: Oct. 18, 2023

Related U.S. Application Data
(63) Continuation of application No. PCT/CN2022/073150, filed on Jan. 21, 2022.

(51) Int. Cl. H04W 72/12; H04L 5/00; H04W 72/232

(52) U.S. Cl. CPC H04W 72/12; H04L 5/0048; H04W 72/232

(57) ABSTRACT

Present implementations are directed to simultaneous uplink transmissions based on multi-TRP operation. In some arrangements, a wireless communication method includes receiving, by a wireless communication device, a first downlink signaling that is associated with a second downlink signaling, and simultaneously transmitting, by the wireless communication device, a first uplink transmission and a second uplink transmission that are scheduled by the first downlink signaling and the second downlink signaling, respectively.

### CROSS-REFERENCE TO RELATED APPLICATION

This application claims the benefit of priority under 35 U.S.C. § 120 as a continuation of PCT Patent Application No. PCT/CN2022/073150, filed on Jan. 21, 2022, the disclosure of which is incorporated herein by reference in its entirety.

### TECHNICAL FIELD

The present implementations relate generally to wireless communications, and more particularly to simultaneous uplink transmissions based on multi-TRP operation.

### BACKGROUND

In conventional wireless systems, uplink transmission only can be implemented in single-Transmission Reception Point (TRP) operation, causing a bottleneck for the reliability of the system where multi-TRP based downlink transmission can be supported. Accordingly, when transmission between the user equipment (UE) and gNB/TRP is negatively impacted on blockage, reliability of an uplink transmission in single-TRP operation is lost, especially in FR2.

### SUMMARY

In order to enhance robustness and reliability for uplink transmission, multi-TRP PUSCH transmission can be supported. With the evolution of mobile communication technology, the UE can be equipped with multiple panels to implement uplink simultaneous transmission for higher capacity. Simultaneous uplink transmissions in Multi-DCI based MTRP operation can advantageously improve the capacity or reliability of downlink command signaling (e.g., DCI) as well as uplink data transmission. To support such transmission schemes, the association between the two DCI indications can be determined for both the base station (BS or gNB) side and the UE side.

As one example, present implementations can introduce a new field in a DCI field to indicate whether the other DCI is to be received in a following time duration, where the two DCI indications can be used to indicate the beam states for two uplink transmission instances. As another example, present implementations can include signaling that configures the association between two DCI indications, where the two DCI indications are used to indicate the beam states for two uplink transmission instances. As another example, present implementations can include a Medium Access Control (MAC) Control Element (CE) that indicates the association between two DCI indications, where the two DCI indications are used to indicate the beam states for two uplink transmission instances. Thus, a technological solution for simultaneous uplink transmissions based on multi-TRP operation is provided.

In some arrangements, a wireless communication method includes receiving, by a wireless communication device, a first downlink signaling that is associated with a second downlink signaling, and simultaneously transmitting, by the wireless communication device, a first uplink transmission and a second uplink transmission that are scheduled by the first downlink signaling and the second downlink signaling, respectively.

In some arrangements, each of the first and second uplink transmission includes a transmission of at least one of a Physical Uplink Shared Channel (PUSCH), a Physical Uplink Control Channel (PUCCH), or a Sounding Reference Signal (SRS).

In some arrangements, each of the first and second uplink transmission includes at least one of a transmission instance, a repetition, or an occasion.

In some arrangements, respective contents of the first uplink transmission and the second uplink transmission are the same or different.

In some arrangements, respective time domain resource of the first uplink transmission and the second uplink transmission are fully or partially overlapped.

In some arrangements, the first downlink signaling includes a first Downlink Control Information (DCI) indication, and the second downlink signaling includes a second DCI indication.

In some arrangements, the first DCI indication and the second DCI indication are configured to indicate a first beam state of the first uplink transmission and a second beam state of the second uplink transmission, respectively.

In some arrangements, a wireless communication method includes separately or jointly receiving, by the wireless communication device, the first DCI indication and the second DCI indication.

In some arrangements, in response to separately receiving the first DCI indication and the second DCI indication, the first DCI indication and the second DCI indication are multiplexed in a time domain, a frequency domain, or a spatial domain.

In some arrangements, the first and second beam states each correspond to a respective User Equipment (UE) panel or a respective Transmission Reception Point (TRP).

In some arrangements, the first and second beam states are each an indicated number of transmission layers or antenna ports, in which the first and second uplink transmissions are each a codebook based PUSCH transmission.

In some arrangements, a total number of the transmission layers or antenna ports is up to 4 across all panels of the wireless communication device.

In some arrangements, the first and second beam states are each a number of codewords, in which the first and second uplink transmissions are each a codebook based PUSCH transmission.

In some arrangements, a total number of the codewords is up to 2 across all panels of the wireless communication device.

In some arrangements, the first and second beam states are each an indicated number of transmission layers or antenna ports, in which the first and second uplink transmissions are each a non-codebook based PUSCH transmission.

In some arrangements, a total number of the transmission layers or antenna ports is up to 4 across all panels of the wireless communication device.

In some arrangements, the first and second beam states are each a number of codewords, in which the first and second uplink transmissions are each a non-codebook based PUSCH transmission.

In some arrangements, a total number of the codewords is up to 2 across all panels of the wireless communication device.

In some arrangements, the first DCI indication includes a first indication field configured to indicate whether the second DCI indication exists.

In some arrangements, a payload of the first indication field has 1 bit.

In some arrangements, in response to determining that a value of the payload of the first DCI indication is equal to a logic 1, a method includes expecting, by the wireless communication device, to receive the second DCI indication within a time duration.

In some arrangements, a method includes receiving, by the wireless communication device, a Radio Resource Control (RRC) signaling indicating the time duration, where the time duration is related to a UE capability reported by the wireless communication device.

In some arrangements, in response to receiving the second DCI indication, a method includes identifying, by the wireless communication device, a value of a payload of a second indication field of the second DCI indication as a logic 0.

In some arrangements, in response to not receiving the second DCI indication within the time duration, a method includes terminating, by the wireless communication device, the expectation of receiving the second DCI indication.

In some arrangements, in response to determining that a value of the payload of the first DCI indication is equal to a logic 0, a method includes expecting, by the wireless communication device, not to receive the second DCI indication.

In some arrangements, the second DCI indication includes a second indication field identical to the first indication field.

In some arrangements, a wireless communication method includes receiving, by the wireless communication device, an RRC signaling, where a presence of the first indication field is configured by the RRC signaling.

In some arrangements, where the first downlink signaling includes a first Physical Downlink Control Channel (PDCCH) carrying a first Downlink Control Information (DCI) indication, and the second downlink signaling includes a second PDCCH carrying a second DCI indication, a method includes receiving, by the wireless communication device, an RRC signaling that configures a relationship between the first DCI indication and the second DCI indication.

In some arrangements, the RRC signaling indicates a relationship between respective Search Spaces (SS) sets of the first PDCCH and second PDCCH.

In some arrangements, respective configuration parameters of the SS sets are different.

In some arrangements, the first PDCCH and second PDCCH are multiplexed in a time domain, a frequency domain, or a spatial domain.

In some arrangements, in response to determining that the first PDCCH and second PDCCH are associated with each other, a method includes expecting, by the wireless communication device, to receive the second DCI indication from the second PDCCH within a time duration.

In some arrangements, in response to not receiving the second DCI indication within the time duration, a method includes terminating, by the wireless communication device, the expectation of receiving the second DCI indication.

In some arrangements, in response to determining that the first PDCCH is not associated with any other PDCCH, a method includes expecting, by the wireless communication device, not to receive the second DCI indication.

In some arrangements, where the first downlink signaling includes a first Physical Downlink Control Channel (PDCCH) carrying a first Downlink Control Information (DCI) indication, and the second downlink signaling includes a second PDCCH carrying a second DCI indication, a method includes receiving, by the wireless communication device, a Medium Access Control (MAC) Control Element (CE) that indicates a relationship between the first DCI indication and the second DCI indication.

In some arrangements, where the MAC CE indicates a relationship between respective Search Spaces (SS) sets of the first PDCCH and second PDCCH.

In some arrangements, respective configuration parameters of the SS sets are different.

In some arrangements, a wireless communication method includes transmitting, by a first wireless communication node to a wireless communication device, a first downlink signaling that is associated with a second downlink signaling, where the second downlink signaling is transmitted by a second wireless communication node, and receiving, by the first wireless communication node, a first uplink transmission and a second uplink transmission that are simultaneously transmitted by the wireless communication device and are scheduled by the first downlink signaling and the second downlink signaling, respectively.

### BRIEF DESCRIPTION OF THE DRAWINGS

These and other aspects and features of the present implementations will become apparent to those ordinarily skilled in the art upon review of the following description of specific implementations in conjunction with the accompanying figures, wherein:

FIG. 1 illustrates an example cellular communication network in which techniques and other aspects disclosed herein may be implemented, in accordance with an implementation of the present disclosure.

FIG. 2 illustrates block diagrams of an example base station and a user equipment device, in accordance with some implementations of the present disclosure.

FIG. 3 illustrates a system in accordance with present implementations.

FIG. 4 illustrates a first method of simultaneous uplink transmissions based on multi-TRP operation in accordance with present implementations.

FIG. 5 illustrates a second method of simultaneous uplink transmissions based on multi-TRP operation further to the method of FIG. 4.

FIG. 6 illustrates a third method of simultaneous uplink transmissions based on multi-TRP operation further to the method of FIG. 5.

FIG. 7 illustrates a fourth method of simultaneous uplink transmissions based on multi-TRP operation further to the method of FIG. 6.

FIG. 8 illustrates a fifth method of simultaneous uplink transmissions based on multi-TRP operation in accordance with present implementations.

FIG. 9 illustrates a sixth method of simultaneous uplink transmissions based on multi-TRP operation in accordance with present implementations.

FIG. 10 illustrates a seventh method of simultaneous uplink transmissions based on multi-TRP operation in accordance with present implementations.

### DETAILED DESCRIPTION

The present implementations will now be described in detail with reference to the drawings, which are provided as illustrative examples of the implementations so as to enable those skilled in the art to practice the implementations and alternatives apparent to those skilled in the art. Notably, the figures and examples below are not meant to limit the scope of the present implementations to a single implementation, but other implementations are possible by way of interchange of some or all of the described or illustrated elements. Moreover, where certain elements of the present implementations can be partially or fully implemented using known components, only those portions of such known components that are necessary for an understanding of the present implementations will be described, and detailed descriptions of other portions of such known components will be omitted so as not to obscure the present implementations. Implementations described as being implemented in software should not be limited thereto, but can include implementations implemented in hardware, or combinations of software and hardware, and vice-versa, as will be apparent to those skilled in the art, unless otherwise specified herein. In the present specification, an implementation showing a singular component should not be considered limiting; rather, the present disclosure is intended to encompass other implementations including a plurality of the same component, and vice-versa, unless explicitly stated otherwise herein. Moreover, applicants do not intend for any term in the specification or claims to be ascribed an uncommon or special meaning unless explicitly set forth as such. Further, the present implementations encompass present and future known equivalents to the known components referred to herein by way of illustration.

A wireless network can include a number of MIMO features that facilitate utilization of a large number of antenna elements at base station for both sub-6 GHz (Frequency Range 1, FR1) and over-6 GHz (Frequency Range 2, FR2) frequency bands, plus one of the MIMO features is that it supports for multi-TRP operation. This functionality can enable collaboration with multiple TRPs to transmit or receive data to the UE to improve transmission performance. As NR is in the process of commercialization, various aspects that require further enhancements can be identified from real deployment scenarios. Present implementations can include at least the following scenarios for uplink transmission in MIMO, which includes single-DCI based MTRP operation and multi-panel based simultaneous UL transmission in STRP operation.

“TRP” can correspond to an SRS resource set, spatial relation, power control parameter set, TCI state, CORESET, CORESETPoolIndex, physical cell index (PCI), sub-array, CDM group of DMRS ports, the group of CSI-RS resources, or CMR set. “UE panel” can correspond to UE capability value set, antenna group, antenna port group, beam group, sub-array, SRS resource set, or panel mode. “Beam state” can correspond to quasi-co-location (QCL) state, transmission configuration indicator (TCI) state, spatial relation (also called as spatial relation information), reference signal (RS), spatial filter or precoding. Furthermore, in this patent, “beam state” can also called as “beam.” “Tx beam” can correspond to QCL state, TCI state, spatial relation state, DL reference signal, UL reference signal, Tx spatial filter or Tx precoding. “Rx beam” can correspond to QCL state, TCI state, spatial relation state, spatial filter, Rx spatial filter or Rx precoding. Beam ID″ can correspond to QCL state index, TCI state index, spatial relation state index, reference signal index, spatial filter index or precoding index.

The spatial filter can be either UE-side or gNB-side one, and the spatial filter is also called as spatial-domain filter. “Spatial relation information” can be comprised of one or more reference RSs, which is used to represent the same or quasi-co “spatial relation” between targeted “RS or channel” and the one or more reference RSs. A “spatial relation” can correspond to the beam, spatial parameter, or spatial domain filter. A “QCL state” can correspond to one or more reference RSs and their corresponding QCL type parameters, where QCL type parameters include at least one of Doppler spread, Doppler shift, delay spread, average delay, average gain, and a spatial parameter. As one example, the spatial parameter can correspond to a spatial Rx parameter. “TCI state” can correspond to “QCL state.” In this patent, there are the following definitions for ‘QCL-TypeA’, ‘QCL-TypeB’, ‘QCL-TypeC’, and ‘QCL-TypeD.’ As one example, ‘QCL-TypeA’ can correspond to one or more of Doppler shift, Doppler spread, average delay, and delay spread. As another example, ‘QCL-TypeB’ can correspond to one or more of Doppler shift, and Doppler spread. As another example, ‘QCL-TypeC’ can correspond to one or more of Doppler shift, and average delay. As another example, ‘QCL-TypeD’ can correspond to a spatial Rx parameter.

RS can correspond to one or more of channel state information reference signal (CSI-RS), synchronization signal block (SSB) (which is also called as SS/PBCH), demodulation reference signal (DMRS), sounding reference signal (SRS), and physical random access channel (PRACH). Furthermore, the RS at least comprises DL reference signal and UL reference signaling. A DL RS can at least comprise CSI-RS, SSB, DMRS (e.g., DL DMRS). A UL RS can at least comprise SRS, DMRS (e.g., UL DMRS), and PRACH. “UL signal” can be PUCCH, PUSCH, or SRS. “DL signal” can be PDCCH, PDSCH, or CSI-RS.

A “codeword” can be a transmission block, the content of a transmission block, a precoder or precoding information.

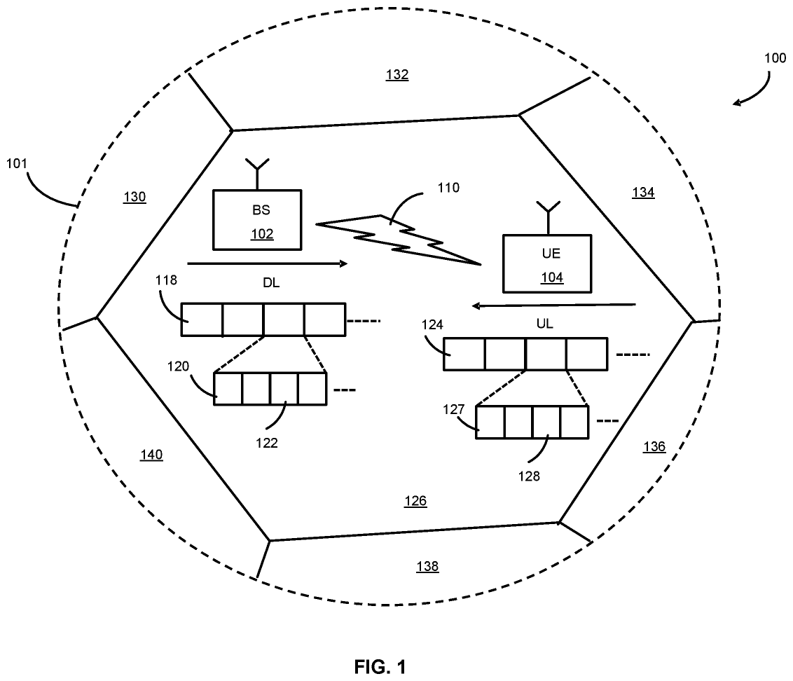

FIG. 1 illustrates an example wireless communication network, and/or system, 100 in which techniques disclosed herein may be implemented, in accordance with an implementation of the present disclosure. In the following discussion, the wireless communication network 100 may be any wireless network, such as a cellular network or a narrowband Internet of things (NB-IoT) network, and is herein referred to as “network 100.” Such an example network 100 includes a base station 102 (hereinafter “BS 102”) and a user equipment device 104 (hereinafter “UE 104”) that can communicate with each other via a communication link 110 (e.g., a wireless communication channel), and a cluster of cells 126, 130, 132, 134, 136, 138 and 140 overlaying a geographical area 101. In FIG. 1, the BS 102 and UE 104 are contained within a respective geographic boundary of cell 126. Each of the other cells 130, 132, 134, 136, 138 and 140 may include at least one base station operating at its allocated bandwidth to provide adequate radio coverage to its intended users.

For example, the BS 102 may operate at an allocated channel transmission bandwidth to provide adequate coverage to the UE 104. The BS 102 and the UE 104 may communicate via a downlink radio frame 118, and an uplink radio frame 124 respectively. Each radio frame 118/124 may be further divided into sub-frames 120/127 which may include data symbols 122/128. In the present disclosure, the BS 102 and UE 104 are described herein as non-limiting examples of “communication nodes,” generally, which can practice the methods disclosed herein. Such communication nodes may be capable of wireless and/or wired communications, in accordance with various implementations of the present solution.

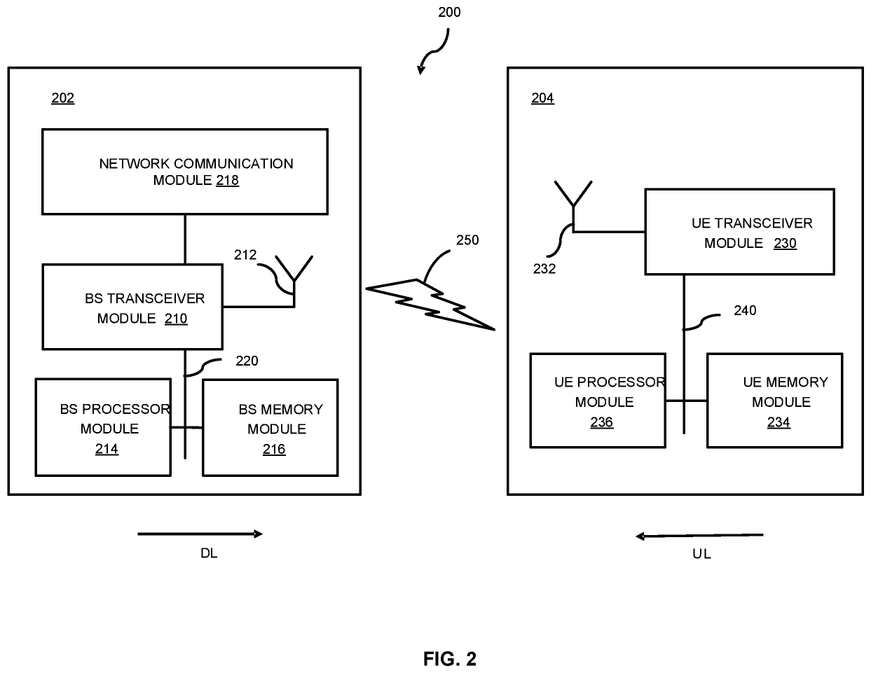

FIG. 2 illustrates a block diagram of an example wireless communication system 200 for transmitting and receiving wireless communication signals, e.g., OFDM/OFDMA signals, in accordance with some implementations of the present solution. The system 200 may include components and elements configured to support known or conventional operating features that need not be described in detail herein. In one illustrative implementation, system 200 can be used to communicate (e.g., transmit and receive) data symbols in a wireless communication environment such as the wireless communication environment 100 of FIG. 1, as described above.

System 200 generally includes a base station 202 (hereinafter “BS 202”) and a user equipment device 204 (hereinafter “UE 204”). The BS 202 includes a BS (base station) transceiver module 210, a BS antenna 212, a BS processor module 214, a BS memory module 216, and a network communication module 218, each module being coupled and interconnected with one another as necessary via a data communication bus 220. The UE 204 includes a UE (user equipment) transceiver module 230, a UE antenna 232, a UE memory module 234, and a UE processor module 236, each module being coupled and interconnected with one another as necessary via a data communication bus 240. The BS 202 communicates with the UE 204 via a communication channel 250, which can be any wireless channel or other medium suitable for transmission of data as described herein.

As would be understood by persons of ordinary skill in the art, system 200 may further include any number of modules other than the modules shown in FIG. 2. Those skilled in the art will understand that the various illustrative blocks, modules, circuits, and processing logic described in connection with the implementations disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software can depend upon the particular application and design constraints imposed on the overall system. Those familiar with the concepts described herein may implement such functionality in a suitable manner for each particular application, but such implementation decisions should not be interpreted as limiting the scope of the present disclosure.

In accordance with some implementations, the UE transceiver 230 may be referred to herein as an “uplink” transceiver 230 that includes a radio frequency (RF) transmitter and a RF receiver each comprising circuitry that is coupled to the antenna 232. A duplex switch (not shown) may alternatively couple the uplink transmitter or receiver to the uplink antenna in time duplex fashion. Similarly, in accordance with some implementations, the BS transceiver 210 may be referred to herein as a “downlink” transceiver 210 that includes a RF transmitter and a RF receiver each comprising circuitry that is coupled to the antenna 212. A downlink duplex switch may alternatively couple the downlink transmitter or receiver to the downlink antenna 212 in time duplex fashion. The operations of the two transceiver modules 210 and 230 can be coordinated in time such that the uplink receiver circuitry is coupled to the uplink antenna 232 for reception of transmissions over the wireless transmission link 250 at the same time that the downlink transmitter is coupled to the downlink antenna 212. In some implementations, there is close time synchronization with a minimal guard time between changes in duplex direction.

The UE transceiver 230 and the base station transceiver 210 are configured to communicate via the wireless data communication link 250, and cooperate with a suitably configured RF antenna arrangement 212/232 that can support a particular wireless communication protocol and modulation scheme. In some illustrative implementations, the UE transceiver 210 and the base station transceiver 210 are configured to support industry standards such as the Long Term Evolution (LTE) and emerging 5G standards, and the like. It is understood, however, that the present disclosure is not necessarily limited in application to a particular standard and associated protocols. Rather, the UE transceiver 230 and the base station transceiver 210 may be configured to support alternate, or additional, wireless data communication protocols, including future standards or variations thereof.

In accordance with various implementations, the BS 202 may be an evolved node B (eNB), a serving eNB, a target eNB, a femto station, or a pico station, for example. In some implementations, the UE 204 may be embodied in various types of user devices such as a mobile phone, a smart phone, a personal digital assistant (PDA), tablet, laptop computer, wearable computing device, etc. The processor modules 214 and 236 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor may be realized as a microprocessor, a controller, a microcontroller, a state machine, or the like. A processor may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the implementations disclosed herein may be embodied directly in hardware, in firmware, in a software module executed by processor modules 214 and 236, respectively, or in any practical combination thereof. The memory modules 216 and 234 may be realized as RAM memory, flash memory, ROM memory, EPROM memory, EEPROM memory, registers, a hard disk, a removable disk, a CD-ROM, or any other form of storage medium known in the art. In this regard, memory modules 216 and 234 may be coupled to the processor modules 210 and 230, respectively, such that the processors modules 210 and 230 can read information from, and write information to, memory modules 216 and 234, respectively. The memory modules 216 and 234 may also be integrated into their respective processor modules 210 and 230. In some implementations, the memory modules 216 and 234 may each include a cache memory for storing temporary variables or other intermediate information during execution of instructions to be executed by processor modules 210 and 230, respectively. Memory modules 216 and 234 may also each include non-volatile memory for storing instructions to be executed by the processor modules 210 and 230, respectively.

The network communication module 218 generally represents the hardware, software, firmware, processing logic, and/or other components of the base station 202 that enable bi-directional communication between base station transceiver 210 and other network components and communication nodes configured to communication with the base station 202. For example, network communication module 218 may be configured to support internet or WiMAX traffic. In a typical deployment, without limitation, network communication module 218 provides an 802.3 Ethernet interface such that base station transceiver 210 can communicate with a conventional Ethernet based computer network. In this manner, the network communication module 218 may include a physical interface for connection to the computer network (e.g., Mobile Switching Center (MSC)). The terms “configured for,” “configured to” and conjugations thereof, as used herein with respect to a specified operation or function, refer to a device, component, circuit, structure, machine, signal, etc., that is physically constructed, programmed, formatted and/or arranged to perform the specified operation or function.

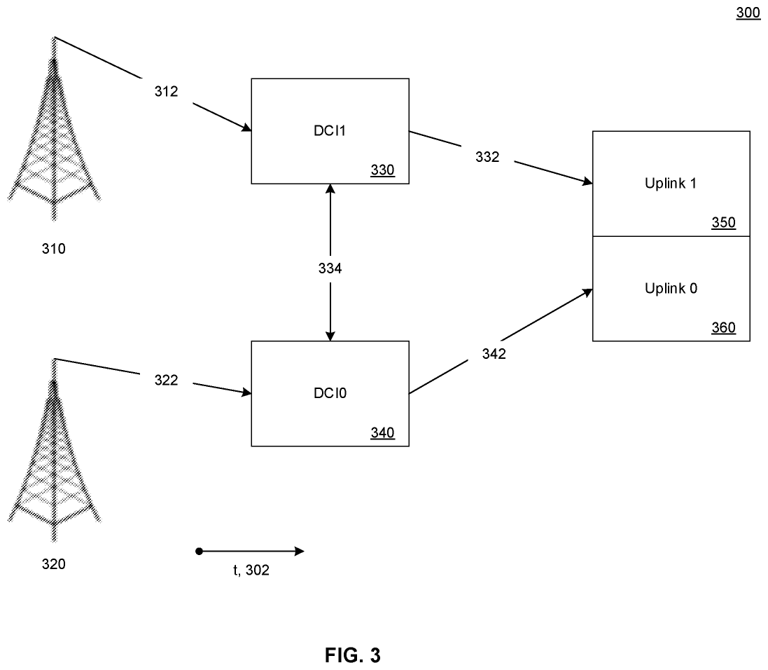

FIG. 3 illustrates a system in accordance with present implementations. As illustrated by way of example in FIG. 3, an example system 300 can include a first time reference 302, a first wireless equipment 310, a first TRP 312, a second wireless equipment 320, a second TRP 322, a first DCI 330, an association 332, a first transmission 334, a second DCI 340, a second transmission 342, a first uplink 350, and a second uplink 360.

In some embodiments, the UE determines the beam states of the first and the second uplink transmission instances and transmits the two uplink transmission instances simultaneously according to the received signaling.

An uplink transmission can be at least one of a Physical Uplink Shared Channel (PUSCH), PUCCH or Sounding Reference Signal (SRS). An uplink transmission can be at least one of a transmission instance, a repetition or an occasion. An uplink transmission can be associated with the same or different CORESETPoolIndex. A PUCCH can be associated with the same or different spatial relation ID. A PUCCH can be associated with the same or different power control parameter set ID. An SRS can be associated with the same or different SRS resource set ID. A PUSCH can be associated with the same or different SRS resource set ID. A PUSCH can be associated with different UE capability value set ID. A PUSCH can be associated with different antenna port group/set ID. A PUSCH can be codebook or non-codebook based transmission scheme.

A received signaling can be a plurality of DCI indications. A number of the plurality of DCI indications can be two. A DCI indication and the other associated DCI indication can be used to indicate the beam states of the first and the second uplink transmissions, respectively. Payloads of the DCI indication and the other associated DCI indication can be different. Contents of the fields in the DCI indication and the other associated DCI indication can be different. Fields can comprise at least one of a carrier indicator, bandwidth part indicator, frequency domain resource assignment, time domain resource assignment, modulation and coding scheme, redundancy version, HARQ process number, TPC command for scheduled PUSCH, SRS resource indicator, precoding information and number of layers, antenna ports, PTRS-DMRS association, or Priority indicator. A beam state of the uplink transmission can be towards a UE panel or a TRP. A beam state of the codebook based PUSCH transmission can be the indicated number of transmission layers or ports. A number of transmission layers or ports can be determined by DCI fields of SRS resource indicator and Precoding information and number of layers. A total number of layers or ports can up to four across all panels.

A beam state of the codebook based PUSCH can be the precoder. A precoder determined by the DCI field of Precoding information and number of layers. A total number of precoder(s) can up to two across all panels. A beam state of the non-Codebook based PUSCH transmission can be the indicated number of transmission layers or transmission ports. A number of transmission layers or ports can be determined by the DCI field of SRS resource indicator. A total number of layers or ports can up to four across all panels. A beam state of the non-Codebook based PUSCH can be the precoder. A precoder can be determined by the DCI field of SRS resource indicator. A total number of precoder(s) can up to two across all panels.

A DCI indication may comprise a indication field to indicate the existence of the other associated DCI indication. A payload of the indication field can be 1 bit. When the value of the 1-bit indication field is 1, the UE can expect to receive the other associated DCI indication. A UE can also expect to receive or monitor the other associated DCI indication within a time duration. A time duration can be configured by RRC signaling and can subjective to the related UE capability reporting. A value of the time duration can be different to different component carriers. As one example, only one can be configured by RRC signaling or reported by UE capability signaling to a specific component carrier. When the UE receives the other associated DCI indication, the value of the indication field in the other associated field can be set to or regarded as 0. When another associated DCI indication is not received within the time duration, the UE can not receive the other associated DCI indication. When a value of the 1-bit indication field is 0, the UE can not expect to receive or monitor the other associated DCI indication. Another associated DCI indication may also comprise the same indicated field as in the DCI indication. RRC signaling can configure whether the indication field can present in the DCI indication.

In some embodiments, the UE determines the beam states of the first and the second uplink transmission instances and transmits the two uplink transmission instances simultaneously according to the received signaling. An uplink transmission can be at least one of PUSCH, PUCCH or SRS. An uplink transmission can be at least one of a transmission instance, a repetition or an occasion. An uplink transmission can be associated with the same or different CORESETPoolIndex. A PUCCH can be associated with the same or different spatial relation ID. A PUCCH can be associated with the same or different power control parameter set ID. A SRS can be associated with the same or different SRS resource set ID. A PUSCH can be associated with the same or different SRS resource set ID. A PUSCH can be associated with different UE capability value set ID. A PUSCH can be associated with different antenna port group/set ID. A PUSCH can be codebook or non-codebook based transmission scheme.

A received signaling can be a plurality of DCI indications. A number of the plurality of DCI indications can be two. A DCI indication and the other associated DCI indication can be used to indicate the beam states of the first and the second uplink transmissions, respectively. Payloads of the DCI indication and the other associated DCI indication can be different. Contents of the fields in the DCI indication and the other associated DCI indication can be different. Fields can comprise at least one of: carrier indicator, bandwidth part indicator, frequency domain resource assignment, time domain resource assignment, modulation and coding scheme, redundancy version, HARQ process number, TPC command for scheduled PUSCH, SRS resource indicator, precoding information and number of layers, antenna ports, PTRS-DMRS association, or Priority indicator. A beam state of the uplink transmission can be towards a UE panel or a TRP. A beam state of the codebook based PUSCH transmission can be the indicated number of transmission layers or ports. A number of transmission layers or ports can be determined by DCI fields of SRS resource indicator and Precoding information and number of layers. A total number of layers or ports can be up to four across all panels.

A beam state of the codebook based PUSCH can be the precoder. A precoder can be determined by the DCI field of Precoding information and number of layers. A total number of precoder(s) can up to two across all panels. A beam state of the non-Codebook based PUSCH transmission can be the indicated number of transmission layers or transmission ports. A number of transmission layers or ports determined by the DCI field of SRS resource indicator. A total number of layers or ports can up to four across all panels. A beam state of the non-Codebook based PUSCH can be the precoder. A precoder can be determined by the DCI field of SRS resource indicator. A total number of precoder(s) can be up to two across all panels.

A first PDCCH which carries the DCI indication and the second PDCCH which carries the other associated DCI indication may be associated by RRC signaling. Two SearchSpace (SS) sets of two corresponding PDCCH can be linked by RRC signaling. Configurable parameters of the two SS sets can be different. Configurable parameters can comprise at least one of periodicity, offset, the number of PDCCH candidates, the aggregation level (AL), the number of monitoring occasions within a slot, or SS set type. Two PDCCH can be transmitted as at least one of Time Division Multiplexing (TDM) scheme, Frequency Division Multiplexing (FDM) scheme, or Spatial Division Multiplexing (SDM) scheme.

When the first PDCCH and the second PDCCH are associated, the UE can expect to receive the other associated DCI indication. A UE can also expect to receive/monitor the other associated DCI indication within a time duration. Otherwise, the UE will NOT receive the other associated DCI indication anymore. A time duration can be configured by RRC signaling and can be subject to the related UE capability reporting. A value of the time duration can be different to different component carriers. Only one can be configured by RRC signaling or reported by UE capability signaling to a specific component carrier. When the first PDCCH is not associated with any other PDCCH, the UE can not expect to receive the other associated DCI indication.

In some embodiments, the UE determines the beam states of the first and the second uplink transmission instances and transmits the two uplink transmission instances simultaneously according to the received signaling. An uplink transmission can be at least one of PUSCH, PUCCH or SRS. An uplink transmission can be at least one of a transmission instance, a repetition or an occasion. An uplink transmission can be associated with the same or different CORESETPoolIndex. A PUCCH can be associated with the same or different spatial relation ID. A PUCCH can be associated with the same or different power control parameter set ID. A SRS can be associated with the same or different SRS resource set ID. A PUSCH can be associated with the same or different SRS resource set ID. A PUSCH can be associated with different UE capability value set ID. A PUSCH can be associated with different antenna port group/set ID. A PUSCH can be codebook or non-codebook based transmission scheme.

A received signaling can be a plurality of DCI indications. A number of the plurality of DCI indications can be two. A DCI indication and the other associated DCI indication can be used to indicate the beam states of the first and the second uplink transmissions, respectively. Payloads of the DCI indication and the other associated DCI indication can be different. Contents of the fields in the DCI indication and the other associated DCI indication can be different. Fields can comprise at least one of carrier indicator, bandwidth part indicator, frequency domain resource assignment, time domain resource assignment, modulation and coding scheme, redundancy version, HARQ process number, TPC command for scheduled PUSCH, SRS resource indicator, precoding information and number of layers, antenna ports, PTRS-DMRS association, or Priority indicator. A beam state of the uplink transmission can be towards a UE panel or a TRP. A beam state of the codebook based PUSCH transmission can be the indicated number of transmission layers or ports.

A number of transmission layers or ports can be determined by DCI fields of SRS resource indicator and Precoding information and number of layers. A total number of layers or ports can be up to four across all panels. A beam state of the codebook based PUSCH can be the precoder. A precoder can be determined by the DCI field of Precoding information and number of layers. A total number of precoder(s) can up to two across all panels. A beam state of the non-Codebook based PUSCH transmission can be the indicated number of transmission layers or transmission ports. A number of transmission layers or ports can be determined by the DCI field of SRS resource indicator. A total number of layers or ports can up to four across all panels. A beam state of the non-Codebook based PUSCH can be the precoder. A precoder can be determined by the DCI field of SRS resource indicator. A total number of precoder(s) can up to two across all panels.

A first PDCCH which carries the DCI indication and the second PDCCH which carries the other associated DCI indication may be associated by MAC CE. As one example, two SearchSpace (SS) sets of two corresponding PDCCH are linked by MAC CE. Configurable parameters of the two SS sets can be different. Configurable parameters comprise at least one of periodicity, offset, the number of PDCCH candidates, the aggregation level (AL), the number of monitoring occasions within a slot, or SS set type. Two PDCCH can be transmitted as at least one of Time Division Multiplexing (TDM) scheme, Frequency Division Multiplexing (FDM) scheme, or Spatial Division Multiplexing (SDM) scheme.

When the first PDCCH and the second PDCCH are associated, the UE can expect to receive the other associated DCI indication. A UE can also expect to receive or monitor the other associated DCI indication within a time duration. Otherwise, the UE can not receive the other associated DCI indication anymore. A time duration can be configured by RRC signaling and can subjective to the related UE capability reporting. A value of the time duration can be different to different component carriers. Only one can be configured by RRC signaling or reported by UE capability signaling to a specific component carrier. When the first PDCCH is not associated with any other PDCCH, the UE can not expect to receive the other associated DCI indication.

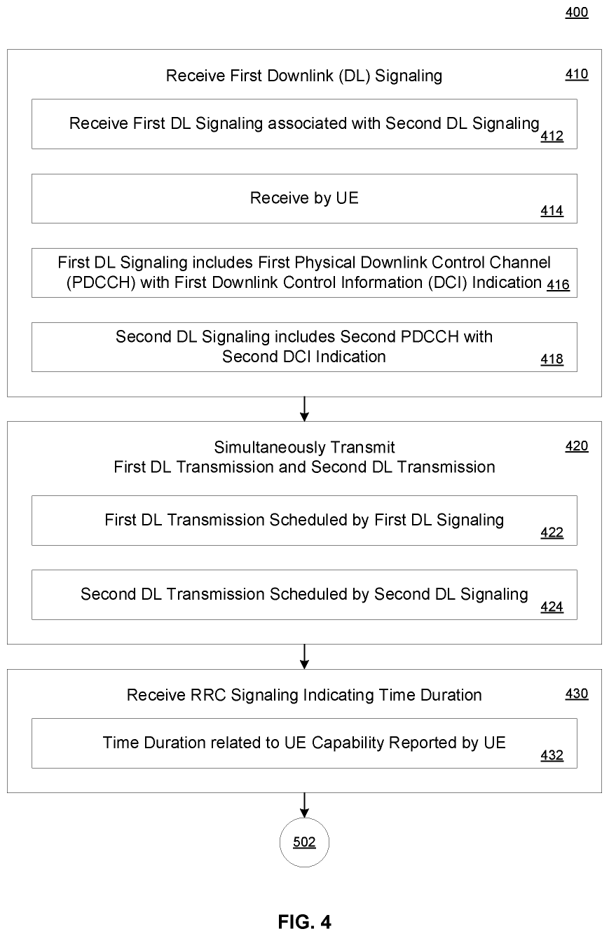

FIG. 4 illustrates a first method of simultaneous uplink transmissions based on multi-TRP operation in accordance with present implementations. At least one of the system 100 or 200 can perform method 400 according to present implementations. The method 400 can begin at step 410.

At step 410, the method can receive first downlink signaling. Step 410 can include at least one of steps 412, 414, 416 and 418. At step 412, the method can receive first downlink signaling associated with second downlink signaling. At step 414, the method can receive by a user equipment. At step 416, the method can receive first downlink signaling that includes a first Physical Downlink Control Channel (PDCCH) with a first DCI indication. At step 418, the method can receive second downlink signaling that includes a second Physical Downlink Control Channel (PDCCH) with a second DCI indication. The method 400 can then continue to step 420.

At step 420, the method can simultaneously transmit a first downlink transmission and a second downlink transmission. Step 420 can include at least one of steps 422 and 424. At step 422, the method can transmit a first downlink transmission scheduled by first downlink signaling. At step 424, the method can transmit a second downlink transmission scheduled by second downlink signaling. The method 400 can then continue to step 430.

At step 430, the method can receive RRC signaling indicating a time duration. Step 430 can include step 432. At step 432, the method can receive RRC signaling indicating a time duration related to UE capability as reported by the UE. The method 400 can then continue to step 502.

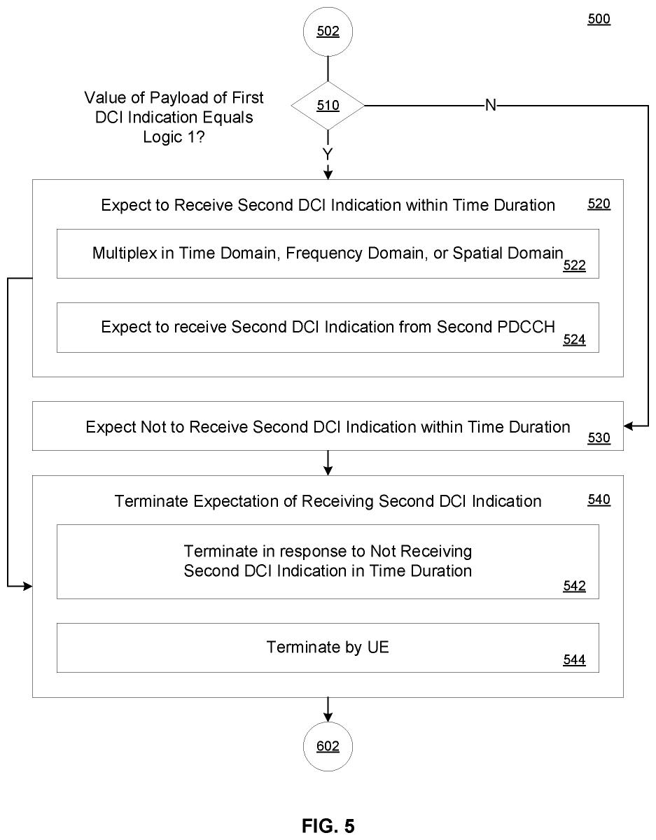

FIG. 5 illustrates a second method of simultaneous uplink transmissions based on multi-TRP operation further to the method of FIG. 4. At least one of the system 100 or 200 can perform method 500 according to present implementations. The method 500 can begin at step 502. The method 500 can then continue to step 510.

At step 510, the method can determine whether a value of a payload of a first DCI indication equals a logical 1. In accordance with a determination that a value of a payload of a first DCI indication equals a logical 1, the method 500 can continue to step 520. Alternatively, in accordance with a determination that a value of a payload of a first DCI indication does not equal a logical 1, the method 500 can continue to step 530.

At step 520, the method can except to receive a second DCI indication within a time duration. Step 520 can include at least one of steps 522 and 524. At step 522, the method can multiplex in at least one of a time domain, frequency domain, or spatial domain. At step 524, the method can expect to receive a second DCI indication from a second PDCCH. The method 500 can then continue to step 530.

At step 530, the method can expect not to receive a second DCI indication within a time duration. The method 500 can then continue to step 540.

At step 540, the method can terminate an expectation of receiving a second DCI indication. Step 540 can include at least one of steps 542 and 544. At step 542, the method can terminate in response to not receiving a second DCI indication in the time duration. At step 544, the method can terminate by the UE. The method 500 can then continue to step 602.

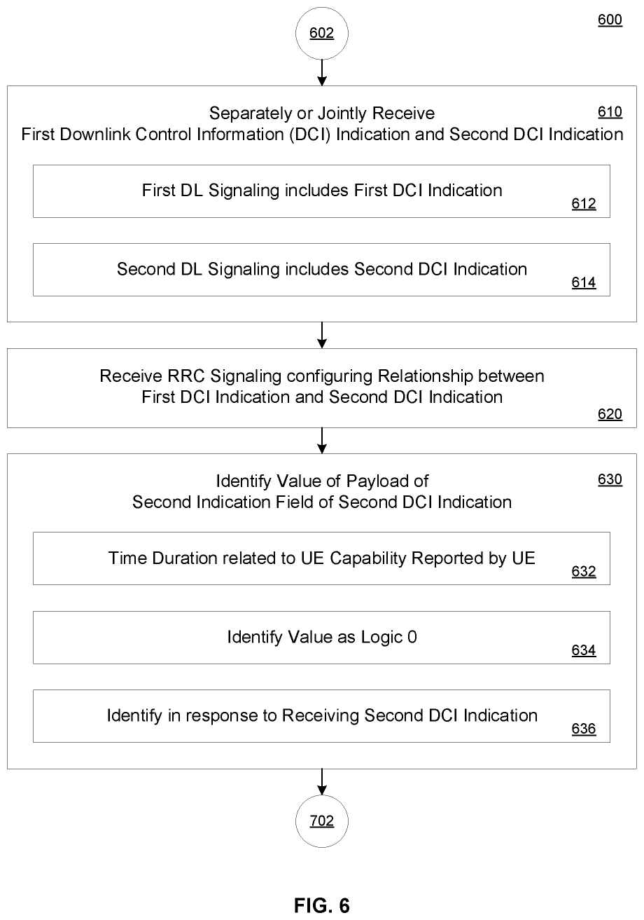

FIG. 6 illustrates a third method of simultaneous uplink transmissions based on multi-TRP operation further to the method of FIG. 5. At least one of the system 100 or 200 can perform method 600 according to present implementations. The method 600 can begin at step 602. The method 600 can then continue to step 610.

At step 610, the method can separately or jointly receive a first DCI indication and a second DCI indication. Step 612 can include at least one of steps 612 and 614. At step 612, the method can receive first downlink signaling that includes a first DCI indication. At step 614, the method can receive second downlink signaling that includes a second DCI indication. The method 600 can then continue to step 620.

At step 620, the method can receive RRC signaling configuring a relationship between a first DCI indication and a second DCI indication. The method 600 can then continue to step 630.

At step 630, the method can identify a value of a payload of a second indication field of a second DCI indication. Step 630 can include at least one of steps 632, 634 and 636. At step 632, the method can identify a value associated with a time duration related to UE capability reported by UE. At step 634, the method can identify a value a logic 0. At step 636, the method can identify in response to receiving a second DCI indication. The method 600 can then continue to step 702.

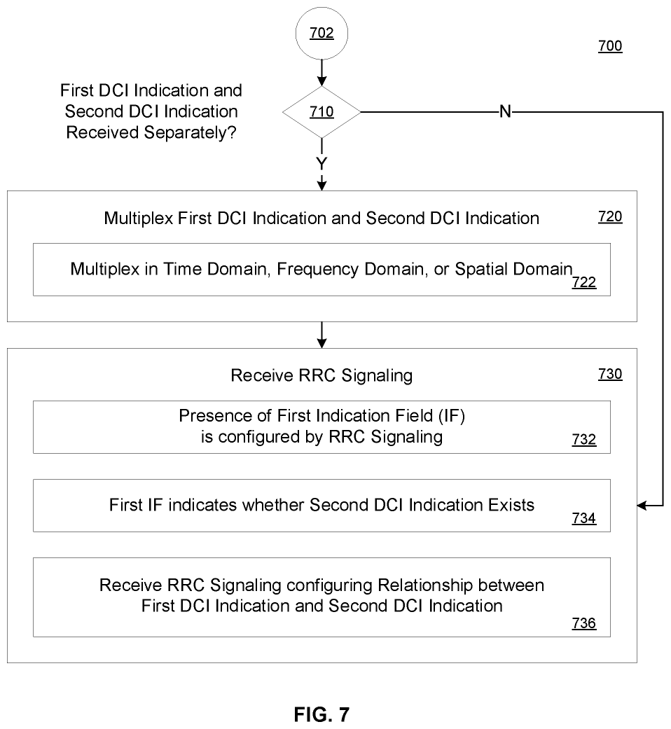

FIG. 7 illustrates a fourth method of simultaneous uplink transmissions based on multi-TRP operation further to the method of FIG. 6. At least one of the system 100 or 200 can perform method 700 according to present implementations. The method 700 can begin at step 702. The method 700 can then continue to step 710.

At step 710, the method can determine whether a first DCI indication and a second DCI indication are received separately. In accordance with a determination that a first DCI indication and a second DCI indication are received separately, the method 700 can continue to step 720. Alternatively, in accordance with a determination that a first DCI indication and a second DCI indication are not received separately, the method 700 can continue to step 730.

At step 720, the method can multiple the first DCI indication and the second DCI indication. Step 720 can include step 722. At step 722, the method can multiplex in at least one of a time domain, frequency domain, or spatial domain. The method 700 can then continue to step 730.

At step 730, the method can receive RRC signaling. Step 730 can include at least one of steps 732, 734 and 736. At step 732, the method can receive RRC signaling where presence of a first indication field is configured by the RRC signaling. At step 734, the method can include a first indication field that indication whether a second DCI indication exists. At step 736, the method can receive RRC signaling configuring a relationship between a first DCI indication and a second DCI indication. The method 700 can end at step 730.

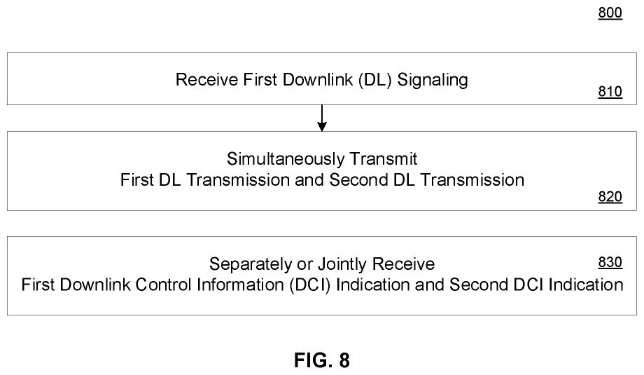

FIG. 8 illustrates a fifth method of simultaneous uplink transmissions based on multi-TRP operation in accordance with present implementations. At least one of the system 100 or 200 can perform method 800 according to present implementations. The method 800 can begin at step 810. At step 810, the method can receive first downlink signaling. The method 800 can then continue to step 820. At step 820, the method can simultaneously transmit a first downlink transmission and a second downlink transmission. The method 800 can then continue to step 830. At step 830, the method can separately or jointly receive a first DCI indication and a second DCI indication. The method 800 can end at step 830.

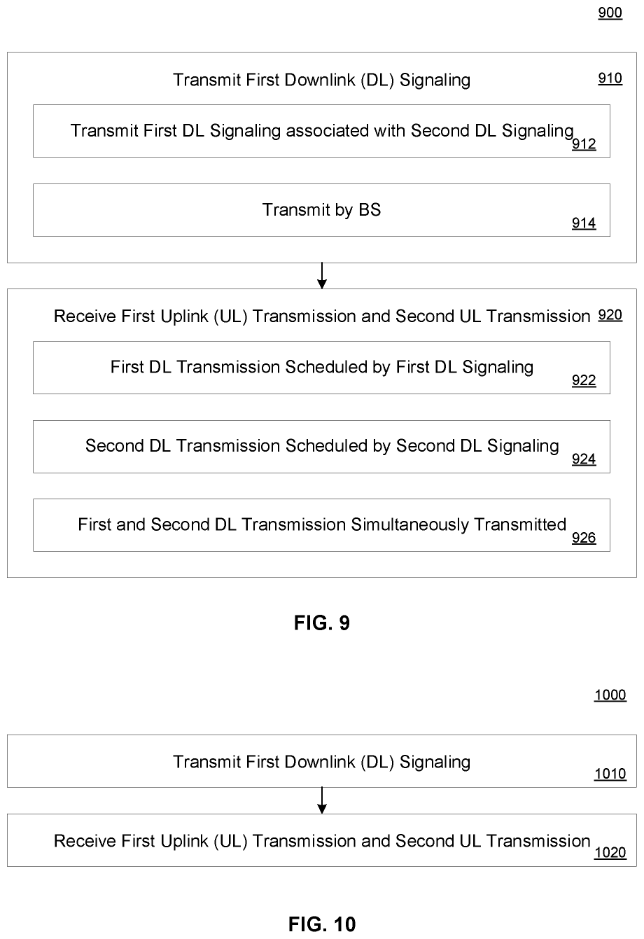

FIG. 9 illustrates a sixth method of simultaneous uplink transmissions based on multi-TRP operation in accordance with present implementations. At least one of the system 100 or 200 can perform method 900 according to present implementations. The method 900 can begin at step 910.

At step 910, the method can transmit first downlink signaling. Step 910 can include at least one of steps 912 and 914. At step 912, the method can transmit first downlink signaling associated with second downlink signaling. At step 914, the method can transmit by BS. The method 900 can then continue to step 920.

At step 920, the method can receive a first uplink transmission and a second uplink transmission. Step 920 can include at least one of steps 922, 924 and 926. At step 922, the method can receive a first downlink transmission scheduled by a first downlink signaling. At step 924, the method can receive a second downlink transmission scheduled by a second downlink signaling. At step 926, the method can receive a first downlink transmission and a second downlink transmission that are simultaneously transmitted. The method 900 can end at step 920.

FIG. 10 illustrates a seventh method of simultaneous uplink transmissions based on multi-TRP operation in accordance with present implementations. At least one of the system 100 or 200 can perform method 1000 according to present implementations. The method 1000 can begin at step 1010. At step 1010, the method can transmit first downlink signaling. The method 1000 can then continue to step 1020. At step 1020, the method can receive a first uplink transmission and a second uplink transmission. The method 1000 can end at step 1020.

The herein described subject matter sometimes illustrates different components contained within, or connected with, different other components. It is to be understood that such depicted architectures are illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It will be further understood by those within the art that if a specific number of an introduced claim recitation is intended, such an intent will be explicitly recited in the claim, and in the absence of such recitation, no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general, such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

Further, unless otherwise noted, the use of the words “approximate,” “about,” “around,” “substantially,” etc., mean plus or minus ten percent.

The foregoing description of illustrative implementations has been presented for purposes of illustration and of description. It is not intended to be exhaustive or limiting with respect to the precise form disclosed, and modifications and variations are possible in light of the above teachings or may be acquired from practice of the disclosed implementations. It is intended that the scope of the invention be defined by the claims appended hereto and their equivalents.

What is claimed is:

1. A wireless communication method, comprising:
receiving, by a wireless communication device, a first downlink signaling that is associated with a second downlink signaling; and
simultaneously transmitting, by the wireless communication device, a first uplink transmission and a second uplink transmission that are scheduled by the first downlink signaling and the second downlink signaling, respectively.

2. The wireless communication method of claim 1, wherein each of the first and second uplink transmission includes a transmission of at least one of: a Physical Uplink Shared Channel (PUSCH), a Physical Uplink Control Channel (PUCCH), or a Sounding Reference Signal (SRS).

3. The wireless communication method of claim 1, wherein each of the first and second uplink transmission includes at least one of: a transmission instance, a repetition, or an occasion.

4. The wireless communication method of claim 1, wherein respective contents of the first uplink transmission and the second uplink transmission are same or different.

5. The wireless communication method of claim 1, wherein respective time domain resource of the first uplink transmission and the second uplink transmission are fully or partially overlapped.

6. The wireless communication method of claim 1, wherein the first downlink signaling includes a first Downlink Control Information (DCI) indication, and the second downlink signaling includes a second DCI indication.

7. The wireless communication method of claim 6, wherein the first DCI indication and the second DCI indication are configured to indicate a first beam state of the first uplink transmission and a second beam state of the second uplink transmission, respectively.

8. The wireless communication method of claim 6, further comprising separately or jointly receiving, by the wireless communication device, the first DCI indication and the second DCI indication.

9. The wireless communication method of claim 7, wherein the first and second beam states each corresponds to a respective User Equipment (UE) panel or a respective Transmission Reception Point (TRP).

10. The wireless communication method of claim 7, wherein the first and second beam states each corresponds to a respective Sounding Reference Signal (SRS) resource set.

11. The wireless communication method of claim 7, wherein the first and second beam states are each an indicated number of transmission layers or antenna ports, in which the first and second uplink transmissions are each a codebook based PUSCH transmission.

12. The wireless communication method of claim 11, wherein a total number of the transmission layers or antenna ports is up to 4 across all panels of the wireless communication device.

13. The wireless communication method of claim 7, wherein the first and second beam states are each a number of codewords, in which the first and second uplink transmissions are each a codebook based PUSCH transmission.

14. The wireless communication method of claim 13, wherein a total number of the codewords is up to 2 across all panels of the wireless communication device.

15. The wireless communication method of claim 7, wherein the first and second beam states are each an indicated number of transmission layers or antenna ports, in which the first and second uplink transmissions are each a non-codebook based PUSCH transmission.

16. The wireless communication method of claim 15, wherein a total number of the transmission layers or antenna ports is up to 4 across all panels of the wireless communication device.

17. The wireless communication method of claim 7, wherein the first and second beam states are each a number of codewords, in which the first and second uplink transmissions are each a non-codebook based PUSCH transmission.

18. A wireless communication method, comprising:
transmitting, by a first wireless communication node to a wireless communication device, a first downlink signaling that is associated with a second downlink signaling, wherein the second downlink signaling is transmitted by a second wireless communication node; and
receiving, by the first wireless communication node, a first uplink transmission and a second uplink transmission that are simultaneously transmitted by the wireless communication device and are scheduled by the first downlink signaling and the second downlink signaling, respectively.

19. A wireless communication device, comprising:
at least one processor configured to:
receive, via a transceiver, a first downlink signaling that is associated with a second downlink signaling; and
simultaneously transmit, via the transceiver, a first uplink transmission and a second uplink transmission that are scheduled by the first downlink signaling and the second downlink signaling, respectively.

20. A first wireless communication node, comprising:
at least one processor configured to:
transmit, via a transceiver to a wireless communication device, a first downlink signaling that is associated with a second downlink signaling, wherein the second downlink signaling is transmitted by a second wireless communication node; and
receive, via the transceiver, a first uplink transmission and a second uplink transmission that are simultaneously transmitted by the wireless communication device and are scheduled by the first downlink signaling and the second downlink signaling, respectively.
